(19) United States
(12) Patent Application Publication
(10) Pub. No.: US 2011/0155931 A1
(43) Pub. Date: Jun. 30, 2011

(54) MAGNETIC DRIVE

(75) Inventor: Johann Weiss, Wangen (DE)

(73) Assignee: SVM SCHULTZ VERWALTUNGS-GMBH & CO.KG, Memmingen (DE)

(21) Appl. No.: 12/967,573

(22) Filed: Dec. 14, 2010

(30) Foreign Application Priority Data
Dec. 15, 2009 (DE) 10 2009 058 165

(51) Int. Cl. F16K 31/08

(52) U.S. Cl. 251/65; 251/129.15

(57) ABSTRACT

The invention refers to a magnetic drive comprising a magnetizable body and an at least partly magnetic hinged armature. Depending on the degree of magnetization of the magnetizable body the hinged armature can take at least two different positions on the body. The hinged armature is formed by an armature support carrying a magnetic armature part.

The invention refers to a magnetic drive comprising a magnetizable body and an at least partly magnetizable hinged armature, wherein the hinged armature on the body is able to take at least two different positions depending on the degree of magnetization of the magnetic body for what the hinged armature folds over a hinge axis.

Furthermore the invention comprises also a magnetic valve that comprises a magnetic drive as described.

### BACKGROUND OF THE INVENTION

Above-mentioned magnetic drives or magnetic valves are known in the state of the art. Thus, the German specification 44 05 657 describes a special magnetic valve where the hinged armature is equipped with two tappets spaced apart that interact in a suitable way with the passage openings of the valve. Depending on the position of the hinged armature, for example, one passage opening is released and the other is closed and vice versa. The arrangement is, for example, chosen such that in a first position the pressure link is closed, and the working link is deaerated through the ventilation link; for this purpose the ventilation link is open. In the second position the pressure link is open, and, at the same time, the ventilation link is closed, so that the medium to be controlled flows in the valve through the pressure link, and leaves the valve again through the working link. The respective passage opening is here connected with the working link or the ventilation link. The mentioned magnetic drives have here a magnetizable body, for example a solenoid that is magnetizised accordingly, when required. In a solenoid the electric power is guided through the windings of the coil that generates the magnetic field. This attracts the magnetic hinged armature, and the switching motion is carried out. Thus the degree of magnetization has, as a rule, two different values, for example “no magnetization” and “magnetization” (if, for example, the power through the coil of the solenoid is on).

Magnetic valves of this type are suited, for example, for adjusting and/or control of flowing media, such as, for example, of gases or also liquids, therefore the range of application comprises, first of all, pneumatic or hydraulic tasks.

The range of application of a magnetic valve is, for the magnetic drive of the type, only one case of application, the invention therefore claims also protection for a magnetic drive in any application.

The concept of motion is focused on the attracting effect of magnets and solenoids, respectively. For example, in the state of the art a magnetizable hinged armature is provided that is designed beam-like and folds, that is swivels, around a hinge axis. The magnetization of the hinged armature is then generated through a suitable material, for example a sintered material (MIM) or another metal or magnetizable material with a suitable magnetizability or possibility of magnetizability and mass.

The entire mass of the hinged armature has to be moved here during the switching motion (from the first to the second position) what requires suitable power if a desired switching speed shall be achieved.

The magnetic hinged armature is moved through an, if required, magnetizable body. For example, a solenoid is provided as magnetizable body. Basically it is possible with increased effort, for example with a bigger coil or a larger number of windings on the coil, to increase the attracting effect of the solenoid, and thus the accelerating force on the hinged armature, however, this is accompanied also by a suitably increased effort (and therefore costs) and a higher weight and constructive volume.

### SHORT SUMMARY OF THE INVENTION

Therefore it is an object of the invention to avoid at least one of the before-mentioned disadvantages, in particular to provide a magnetic drive that switches faster.

This problem is solved by a magnetic drive as described in the beginning where it is suggested that the hinged armature is formed by an armature support carrying a magnetic armature part that interacts with the magnetic body. The invention suggests a basically two-part hinged armature formed by an armature support that receives the magnetic armature part. This solution leads to a surprisingly large number of advantages.

The suggestion according to the invention allows, first of all, to realize the hinged armature significantly lighter with identical magnetic qualities what leads, because of the lower mass to be accelerated, while the attracting power generated by the body remains the same, to a higher acceleration and therefore to lower switching times. The suggestion according to the invention allows furthermore employing the rather expensive magnetic material of the hinged armature effectively. Namely only in the area where it is perfectly positioned and highly efficient in interaction with the magnetizable body a magnetic armature part is arranged on the hinged armature according to the invention. In particular, also a suitable magnetic armature part is used for locking the magnetic flow. However, this determines a sufficient size of the magnetic armature part, and therefore a suitably smaller mass of the magnetic material of the hinged armature. The rather expensive material can be saved.

The suggestion according to the invention also presents the chance of dimensioning the magnetizable body, for example a solenoid drive (a coil), smaller to achieve the same or even better switching qualities of the hinged armature. This is accompanied by less effort for realizing the magnetizable body, and a low power consumption during the switching process. In addition to that the constructive dimension can be reduced.

In a preferred embodiment of the invention the armature support is made of a material different from the magnetic armature part. The effect according to the invention (for example reduction of production costs), however, is also achieved with an arrangement where armature support and armature part consist of basically identical material, however, the armature part has additionally a magnetic activation. The magnetic activation can be limited here just to the armature part.

It is another advantage of the invention that the magnetic quality of the armature part can be positioned spatially in exactly that way as the magnetizable body in the magnet drive becomes active. Usually, the hinged armature is altogether bigger than the magnetic armature part, and also, through the concentration of the magnetic quality of the hinged armature on the magnetic armature part, the control dissipation and resulting mechanical restrictions are avoided effectively by the suggestion according to the invention.

In a preferred embodiment of the invention it is provided that the armature support consists of a light-weight material, metal, light metal, for example aluminum or also plastic. Besides homogenous plastic materials the invention also comprises fiber-reinforced plastic materials that are used for forming the armature support; here, for example, carbon fibers or glass fibers are used. The effect according to the invention of saving weight on the armature support is realized, for example, even with an armature support formed by a plane metal piece that is manufactured, for example, as stamp or stamp-fold part of a plane (sheet) metal part. Sufficient stability for the use of the magnetic drive is combined here with low weight and low manufacturing costs while nevertheless the magnetic qualities that also depend on the choice and dimensioning of the armature part are sufficient.

Usually, the armature support according to the invention is designed beam-like, and extends with reference to the spatial design over the magnetizable body to receive, for example in its marginal area, suitable control elements such as one or more seal nipples, or one or more tappets.

Cleverly the magnetic armature part is designed as permanent magnet, however, the invention is not restricted to that. The armature part is formed here, for example, of sintered materials, such as sintered metal (MIM) or other metallic materials.

In a preferred embodiment of the invention the armature support is not designed as profile part, but the armature support is provided at least on one side with an obtuse angle to form a rocker edge. According to the invention it is provided here that the separation surface of the armature support facing the magnetizable body or facing away from the magnetizable body is formed of at least two partial surfaces butting in particular each time on one rocker edge. According to the suggestion of the invention here also both separating surfaces can be realized each with butting partial surfaces. The rocker edge(s) forming here convex or concave serve(s) then, if necessary, also as rest or support area just during the rocker or folding motion of the hinged armature.

For mounting the hinged armature is then put on the magnetizable body, and, if necessary, held by an activation of the magnetizable body (for example switching on the current flow through the magnet coil). The hinged armature, however, is supported sufficiently mobile in a drive housing, in particular a lid is provided that receives the hinged armature and that is arranged on the side facing away from the body. In the lid one or more support knobs or ribs are provided for the armature interacting, if necessary, also with the rocker edge of the armature support, or that is/are arranged in its surroundings on the respective partial surface. The lid is here arranged on the side facing away from the body, and therefore is/are arranged also one or more support knobs or ribs on the side facing away from the body, and interact with the hinged armature.

The arrangement is here chosen in such a way that the hinged armature keeps a certain mobility or clearance to be able to carry out the folding motion, that is a swiveling motion, around the rocker edge and around the support knobs or rips, respectively. The rocker axis is here, as also preferably the rocker edge, essentially orientated rectangular to the longitudinal extension of the beam-shaped armature support.

In a preferred embodiment of the invention it is provided that the hinged armature has at least one recess, passage opening or guide groove, and on the lid and/or in the housing part, that receives in particular the magnetic body, a guiding pin or guiding bridge projecting in the recess, passage opening or the guide groove is provided. By means of this modification according to the invention the hinged armature, in particular either the armature support or also alternatively the magnetic armature part, is equipped with a recess (for example like a pocket hole) or with a guide groove, that may also be designed as passage opening, to thread the hinged armature here on a guiding bridge or pin. The support of the hinged armature on the guiding bridge, that may also be designed pin-like and then interacts with a suitable passage opening, is done here with sufficient clearance so that the hinged armature is able to carry out a desired folding or rocking motion. It is then supported, for example, on the end of the bridge, or the guide groove has a corresponding width that is clearly larger than the width of the guiding bridge so that a corresponding free motion or folding clearance remains. The arrangement can be realized here alternatively in such a way that the guiding bridge is arranged either on the lid or on the housing part receiving the magnetic body. It is, of course, also possible to arrange the guiding bridge in the area of the magnetic body, what is also comprised by the invention. It is also possible to arrange one partial bridge of the guiding bridge each on the lid as well as on the housing part, and the result is that the guiding bridge is divided in two partial bridges. In this modification the guiding bridge is divided in two partial guiding bridges arranged on the housing part and the lid, respectively.

In a preferred embodiment of the invention the magnetic body is formed by a coil carrying wire windings that can be flown through by electric current. Alternatively to that it is possible that the magnetic body is formed by a movable permanent magnet. The arrangement is here chosen in such a way that the magnetic body can be activated in a suitable way to act on the magnetic armature part and to realize the desired switching motion of the magnetic drive.

Preferably the magnetic body is not only formed by a coil but by a pair of coils that is put on a U-shaped yoke designed preferably rectangular. In a preferred embodiment here in particular a hinged coil is provided consisting of two coil areas that are arranged unfolded while the coil is winded, that is in such a way that the result is a longitudinally extending coil body divided in two parts that can be collapsed, that is also folded, when the winding has been finished, and has two coils that are, after that, arranged parallel, if necessary also symmetric that can be slid on the limbs of the U-shaped yoke. The two coil areas are here connected to each other by a hinge, for example also a film hinge to provide a suitable fixing but also mobility.

As already explained, the invention does not only comprise a magnetic drive, but it also refers to a magnetic valve equipped with a suitable magnetic drive according to the invention where it is provided that in a valve housing with at least one passage opening which can be opened and closed, respectively, the hinged armature carries at least one tappet interacting with the passage opening. In particular in application fields of a magnetic valve efficient and quick switching of the passage openings is decisive, wherein with the magnetic valves according to the invention any medium (gas or liquid) can be controlled or adjusted.

The magnetic valve according to the invention comprises at least one tappet that may also act nipple-like. As it is in particular explained in the drawings, the hinged armature is equipped in a particular application with one tappet or nipple each in the end area of the beam-like hinged armature to interact there with a passage opening. The arrangement is here chosen in such a way that, depending on the position of the hinged armature, the tappet or nipple closes or releases the respective passage opening.

In a preferred embodiment of the magnetic valve according to the invention it is provided that the housing part of the valve housing facing the hinged armature serves as lid of the drive housing. Cleverly here also one or more passage openings that are controlled by the nipple or tappet, which are arranged on the hinged armature, are arranged in the valve housing. This modification cleverly has a double function, as, on the one hand, it takes over the tasks of the valve or the valve housing, provides in particular the passage opening, and, on the other hand, is provided as lid of the drive housing, for example as support for the hinged armature as described.

According to the invention the drive housing is designed in one piece or also multi-pieced. Also the lid belonging to the drive housing itself can be designed again in one piece or multi-pieced.

The use of a magnetic drive according to the invention is in a magnetic valve such, that, for example, the tappet serving as nipple of the hinged armature, with reference to its position, is directed to a passage opening and opens or closes it, if necessary opens, that means adapts and controls, even only a part. In such a design the hinged armature is arranged in the valve space flown through by the medium that otherwise is designed suitably impenetrable.

An alternative embodiment provides that the hinged armature is separated from the valve space by a membrane, and the tappet acts on the passage opening via a membrane part or a membrane area. Advantageously, here the tappet is connected, if necessary, at least non-positive with the membrane part to carry out the opening or closing motion reliably. The non-positive connection can be realized, for example, by a positive or contact (for example by gluing, welding, one-piece production and so on) connection.

### BRIEF DESCRIPTION OF THE DIFFERENT VIEWS OF THE DRAWINGS

In the drawing the invention is shown in particular schematically in different embodiments. In the figures:

FIGS. 1a, 1b, 2a, 2b and 3a a magnetic valve according to the invention using a magnetic drive according to the invention each in a sectional view in different positions (FIGS. 1a, 2a in a first position, FIGS. 1b, 2b in a second position);

FIGS. 2c and 2d details of different embodiments of the support for the hinged armature and

FIGS. 3b to 3d details of different embodiments of a hinged armature that can be used in a magnetic valve according to the invention, each in a perspective view.

### DETAILED DESCRIPTION OF THE PREFERRED EMBODIMENT

In the figures identical or corresponding elements each are indicated by the same reference numbers and therefore are, if not useful, not described anew.

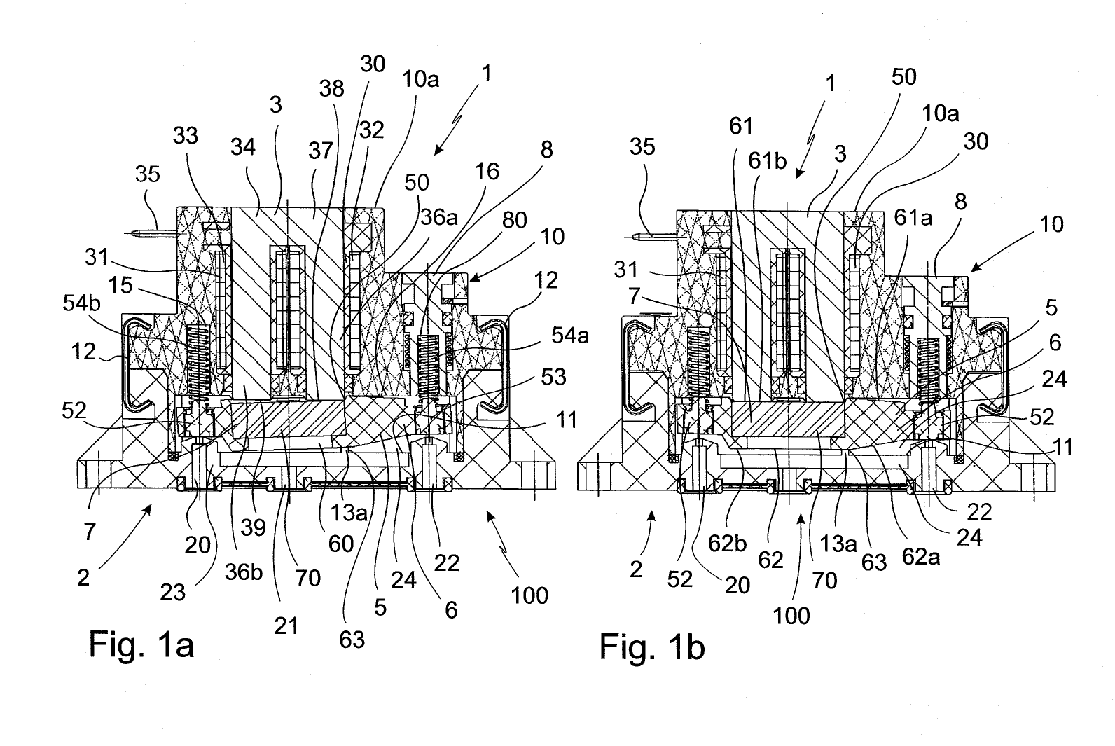

The magnetic valve 100 according to the invention is in an example in FIG. 1a. Roughly, the magnetic valve 100 according to the invention consists of the magnetic drive 1, and the valve housing 2 arranged on the bottom side (however, this may also be on the top side seen in technical respect), receiving several medium connections which run in the passage openings 20, 21,22.

In each of the modifications shown in these examples the left passage opening 20 serves as link of the pressure line, the centrally arranged passage opening 21 is connected with the working connection, the passage opening 22 arranged on the right hand side serves as link to the ventilation line. The passage opening 20 associated with the pressure line on the left hand side and the passage opening 22 arranged on the right hand side and associated with the ventilation line are opened and closed, respectively, depending on the position of the hinged armature 5.

The working connection connected with the centrally arranged passage opening 21 cannot be closed in this modification.

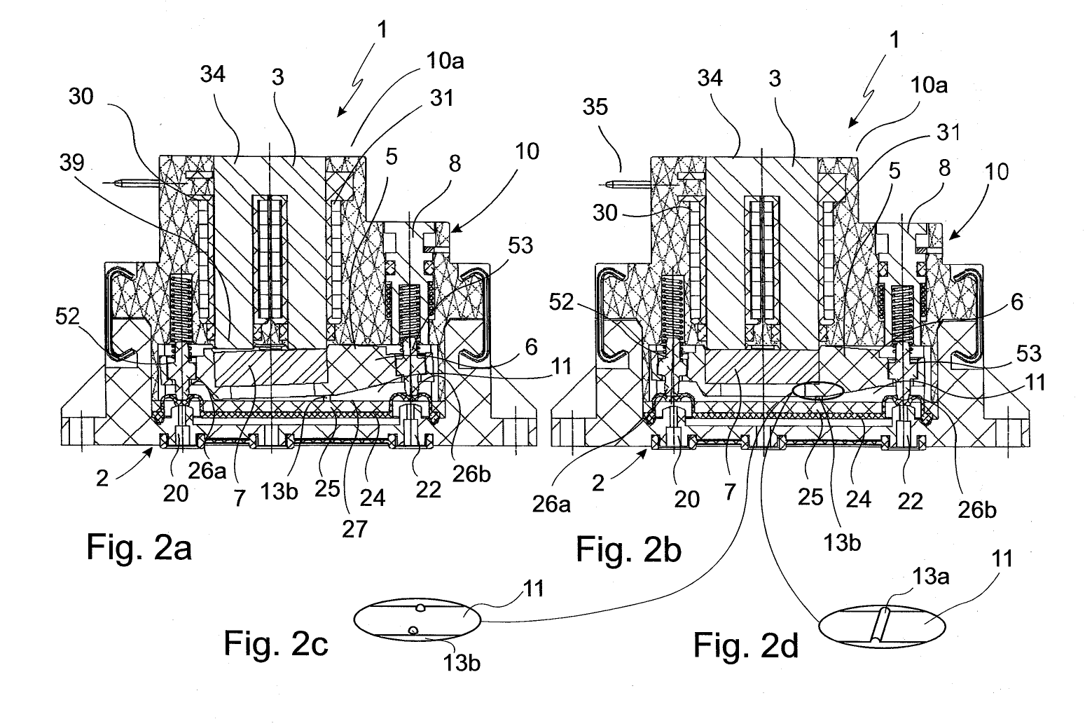

It is obvious that the design of the valve part of the magnetic valve 100 is very variable and can be adjusted to different situations. Of course, the invention is not restricted to the embodiment shown here. The magnetic drive 1 consists of a magnetizable body 3 and an at least partly magnetic hinged armature 5. The hinged armature 5 takes different positions on the magnetic body here depending on the degree of magnetization of the magnetic body 3, in the embodiment shown here the hinged armature 5 takes two different positions that are shown, on the one hand, in FIGS. 1a, 2a, on the other hand, in FIGS. 1b, 2b.

The hinged armature 5 is formed, according to the invention, by an armature support 6 carrying a magnetic armature part 7. This magnetic armature part 7 interacts with the magnetizable body 3.

The entire magnetic drive 1 is arranged in a drive housing 10, the top housing part 10a of the drive housing 10 is connected fixedly by lateral connecting clamps 12 with the drive housing 2.

In the example shown here the magnetic body 3 consists of a U-shaped yoke 34. The yoke 34 consists here of two parallel extending limbs 36a, b connected by the rectangular linked bridge 37. The U-shaped yoke 34 is arranged here opened downward in the direction of the hinged armature 5 arranged below. The yoke 34 consists here of magnetizable material and serves for bundling and guiding the magnetic field lines.

The magnetic field is generated in the embodiment shown here by two coils or coil bodies 30, 31 arranged one beside the other and carrying windings 32, 33, namely when electric current, for example via the link contacts 35, impinges or flows through the windings 32, 33.

FIG. 1a (and FIG. 2a) shows the non-current position. This means, there is an air gap 39 between the separation surface facing the hinged armature 5 and the hinged armature 5. According to the invention the hinged armature 5 is designed multi-piece. It consists of an armature support 6 and an armature part 7 held by the armature support 6. The armature support 6 is created preferably of a non-magnetic or low-magnetic material to prevent an influence on the other magnetic qualities of the magnetic drive. The armature support 6 is realized beam-like extending longitudinally, and extends over the entire width of the yoke 34. About in the middle the armature support 6 carries the magnetic armature part 7, the length of the armature part 7 corresponding here essentially with the width of the magnetic body 3, in particular the yoke 34. Generally, it is provided according to the invention that the width of the armature part 7 corresponds about 75% to 150% with the width of the magnetic body 3, in particular the yoke 34. Preferably, here an interval for the width of the armature part 7 of about 80% to 120% of the width of the magnetic body 3 has been found.

The armature part 7 is held by the armature support 6. For that the armature support 6 is designed clearly longer than the width of the armature part 7. In the embodiment of FIG. 1a the width of the armature part 7 is about 40% of the length of the armature support 6. According to the invention it has proved convenient to chose the width of the armature part 7 between 20% and 55% of the length of the armature support 6, preferably between 30% and 50%. Here a good ratio between the available magnetic attraction and the available mechanic levers has been found.

The height of the armature support 6 is about 18% of its length, and is provided, according to the invention, in an interval of 10% to 35%, preferably of 12% to 25%.

The hinged armature 5 is one of the movable elements of the magnetic drive 1. Therefore the support of the hinged armature 5 is chosen in such a way that it can carry out a swiveling motion. The way of swiveling is rather small, and is only a few degrees, the air gap 39 is closed here (see FIG. 1b). The hinged armature is moved when the windings 32, 33 on the coil bodies 30, 31 are impinged by electric current, and the forming magnetic field attracts the magnetic armature part 7 of the hinged armature 5. The hinged armature 5 folds or swivels here around a hinge axis 50. This is in the example shown here vertically on the plane of drawing, and rectangular to the longitudinal extension of the armature support 6. The hinge axis 50 is here on the top side of the hinged armature 5 facing the magnetizable body 3. As bottom part 7, for example, a permanent magnet 70 is provided.

The armature support 6 is realized in the embodiment shown here beam-like, and has a recess 60 for weight reduction in the area of the armature part 7. The recess 60 is provided here on the side facing away from the magnetizable body 3. The hinged armature 5 is realized rocker-like, wherein the two rocker arms extending left and right of the hinge axis 50 have a differing length.

The hinge axis 50 is positioned in the example shown here on the right end of the magnetizable body 3, and thus also on the right end of the armature part 7.

The magnetizable body 3 is here surrounded by the material of the drive housing 10, for example a casting compound. The arrangement, however, is chosen in such a way that the front separation surface 38 of the yoke 34 projects beyond the separation surface 16 with that the hinged armature 5 is in contact.

In the example shown here the rocker arm of the hinged armature 5 extending to the left from the hinge axis 50 is a bit longer than the right rocker arm. The asymmetry is from about 62% to 38%, and is, according to the invention, in an interval of 75% to 55%, up to 25% to 45%. Of course, it is also possible that both rocker arms have approximately the same length or have actually identical lengths.

Through the different lengths of the rocker arms, according to the invention, the lever principle is employed what makes in particular in the non-current position a reliable sealing of the pressure link on the passage opening 20 easier. FIG. 1a shows also the fallen-off position of the magnetic drive 1, and the passage opening 20 is sealed by the nipple-like tappet 52.

In the case of application of a magnetic valve 100 shown here the (movable) hinged armature 5 carries one or more tappets 52, 53 in particular also serving as nipples. The tappets 52, 53 are arranged in the longitudinal end area of the hinged armature 5 on or in the armature support 6. For that the armature support 6 has a recess in that the tappet 52, 53 is inserted, wherein the tappet 52, 53 has a certain mobility or clearance, preferably rectangular to the longitudinal extension of the armature support 6 or the hinged armature 5.

Preferably in the application case shown in FIGS. 1a, 1b the tappet 52, 53 has a sealing quality, that means it acts as nipple and consists, for example, of elastomers or other sealing materials.

For a save sealing of the respective passage openings 20, 22 by the tappet 52, 53 associated with the passage openings for each of the tappets 52, 53 one tappet spring 54a, b is arranged.

The tappet spring 54b engaging on the left tappet 52 is here in a pocket hole boring 15 of the drive housing 10, and is supported on the bottom of this pocket whole boring 15.

The tappet spring 54a engaging on the right tappet 53 is supported in a manual emergency control 8, and is supported there. The manual emergency control 8 is designed, for example, as movable pin arrangement, and has also a pocket hole boring 80 on its ends facing the hinged armature 5. In the case that the magnetizable body 3 fails, for example the windings cannot be fed by current, it is possible through the manual emergency control 8 to act directly on the tappet 53 and to press it on the passage opening what makes a switching of the valve from the position of FIG. 1a in the position of FIG. 1b (analogously FIG. 2a to FIG. 2b) possible. Here the manual emergency control 8 acts immediately on the tappet 53, compresses here the tappet spring 54a and operates also the hinged armature 5 as well as the opposite tappet 52.

Because of the rocking or folding motion of the hinged armature 5 in the magnetic drive 1 the armature support 6 and the hinged armature 5, respectively, are mot designed prismatically, but have suitable chamfers.

Thus the hinged armature 5 and the armature support 6, respectively, are designed in the right hand area, with reference to the hinge axis 50, conically or wedge-like tapering.

On the left hand side of the hinge axis 50 the armature support 6 is equipped with essentially parallel extending separation surfaces 61, 62 to taper on the end side and to receive there the (left) tappet 52.

The separation surface 61 is arranged here on the armature support 6 on the side facing the magnetizable body 3, the separation surface 62 is arranged on the side facing away from the magnetizable body 3.

The separation surface 61 of the armature support 6 facing the body 3 is formed here of at least two partial surfaces 61a, b butting in particular on a rocker edge. The separation surface 62 facing away from the body 3 is formed by two partial surfaces 62a, b butting on a rocker edge. As the separation surface 16 of the drive housing 10 recedes from the separation surface 38 on the magnetizable body 3, in the area of the hinge axis 50, where, of course, also a rocker edge forms, on the separation surface 61 facing the magnetizable body 3 a small shoulder is arranged between the two partial surfaces 61a, b. This shoulder already carries out a certain support and positioning of the hinged armature 5 and the armature support 6, respectively, in the drive housing 10.

The drive housing 10 has a lid and the hinged armature 5 is provided below. The lid 11 has in the area of the rocker edge 63, that is arranged on the separation surface 62 facing away from the magnetizable body 3, one or more support knobs 13a or ribs 13b for a support of the hinged armature 5. The embodiment with support knobs 13a is shown in a section in FIG. 2c, the embodiment with a support rib 13b in FIG. 2d. FIGS. 2a and 2b show an embodiment with support ribs 13b, while the arrangement of support knobs 13a is shown in FIGS. 1a and 1b. The design is here chosen in such a way that, of course, a folding or swiveling motion of the hinged armature 5 around its hinge axis 50 remains possible, that means a section of the separation surface 62 glides, if necessary, on the support knobs 13a or the support ribs 13b. The arrangement is here chosen such that the hinged armature 5 remains reliably in position, therefore there is a certain clearance or a suitable fit between the support knobs 13a or the support ribs 13b and the separation surface 62.

The arrangement of the support knobs 13a or the support ribs 13b does not remain limited to each of the shown embodiments, but it can be exchanged or used optionally with the possible embodiments.

As already explained, the lid 11 is in the case of application of a magnetic valve 100 simultaneously also the valve housing lid 23 limiting the valve space 24. The valve space 24 is here connected with the respective connecting lines, depending on the position of the nipples or tappets 52, 53, relatively to the respective passage openings 20, 22. In the modification shown in FIGS. 1a, 1b the medium to be controlled flows also through the hinged armature 5 as the hinged armature 5 is arranged in the valve space 24.

If aggressive media have to be controlled or adjusted with the magnetic valve according to the invention it may be convenient to arrange a membrane 25 between the valve space 24 and the hinged armature 5. In this case the support knobs 13a or the support rib 13b are/is arranged on a membrane carrier 27. The support knobs 13a or support ribs 13b face the hinged armature 5, and the membrane is provided on the side facing away from the support knobs 13a or support ribs 13b. The membrane carrier 27 provides an additional separation wall between the valve space 24 and the hinged armature 5.

In the area of the passage openings 20, 22 that have to be sealed or opened the membrane 25 has hat-like membrane parts 26a, b interacting with the tappets 52, 53. The hat-like membrane parts 26a, b cover the passage openings 20, 22, wherein these, facing the tappets 52, 53, have a recess for fixing the membrane part 26a, b on the respective tappet 52, 53. Here preferably an at least non-positive connection between the tappet 52, 53 and the membrane part 26a, b is provided in order to transfer the control motion of the hinged armature 5 reliably to the membrane part 26a, b forming the seal.

In FIGS. 1a, 1b as well as in FIGS. 2a, 2b each time two different switching positions of the magnetic valve 100 are shown. In the (fallen-off) position of the solenoid, in particular in the non-magnetic position of the magnetizable body 3 the pressure link on the left passage opening 20 is sealed immediately (the tappet is nipple-like) or indirectly (the tappet 52 acts on the membrane part 26a), see FIGS. 1a and 2a.

The working link connected centrally to the unclosed passage opening 21 is deaerated via the ventilation link connected to the right passage opening 22, for that this passage opening is not closed by the tappet 53.

In the activated position (see FIG. 1b and FIG. 2b, respectively) the hinged armature 5 folds around a few degrees (1° to 5°, the air gap 39 between the yoke 34 and the hinged armature 5 is closed. The resulting clockwise motion opens the left passage opening 20 (the pressure link) and seals simultaneously the right passage opening 22 (the ventilation link). The working pressure connected with the pressure link is available on the working link (passage opening 21).

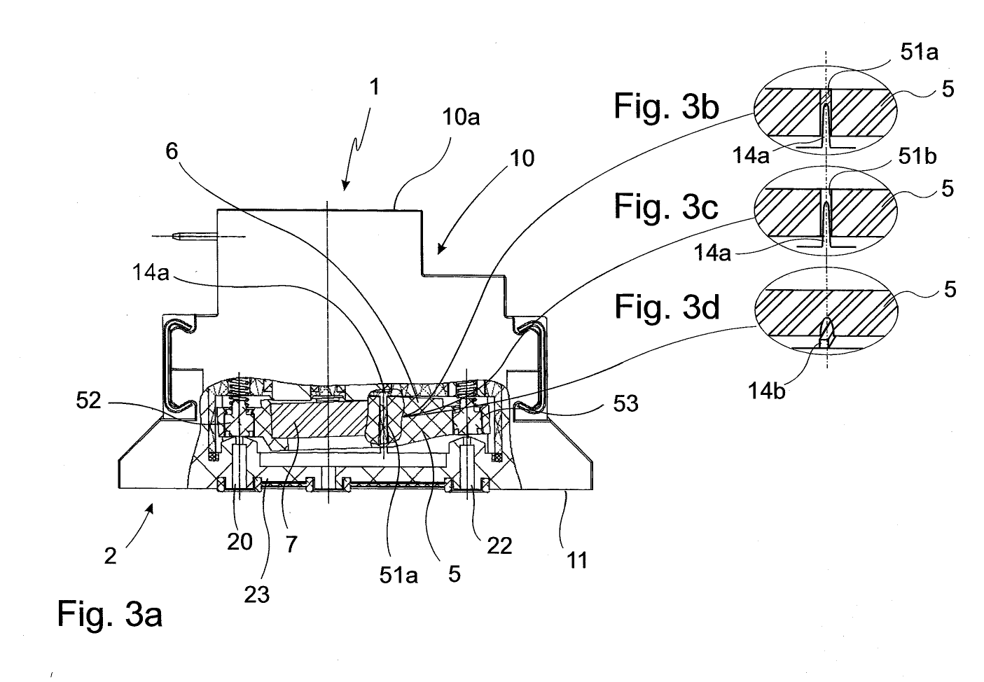

FIG. 3 shows another alternative support concept of the hinged armature 5, what may be shown here in the modification without membrane, however, it can be transferred to the modification with membrane without any problems. Instead of support knobs 13a or support ribs 13b here in the hinged armature 5, in particular in the armature support 6, a guide groove 51c is provided a guide pin 14a projecting in it that extends rectangular from the lid 11, and that guides the hinged armature 5 or the armature support 6. Here the thickness of the guide pin 14a and the width of the guide groove 51 are chosen with sufficient clearance that the mobility of the hinged armature 5 around the hinge axis 50 remains possible.

Beside the embodiment shown here with a guide pin 14 projecting in the guide groove 51 there is the possibility of providing in the hinged armature 5 a passage opening 51b or a recess 51c, and the guide pin 14a, also designed as guide bridge 14b (see FIGS. 3b and 3c), projects in it. The embodiments of guide pin 14a or guide bridge 14b or recess 51c, the passage opening 51b or the guide groove 51a that can be optionally be used or combined with all possible embodiments of the invention reciprocally, are all shown in the detailed drawings of FIGS. 3b to 3d.

Although the invention has been described by exact examples that are illustrated in the most extensive detail, it is pointed out that this serves only for illustration, and that the invention is not necessarily limited to it, as alternative embodiments and methods become clear for experts in view of the disclosures. Accordingly, changes can be considered that can be made without departing from the contents of the described invention.

1. Magnetic drive comprising a magnetizable body and a hinged armature at least partly magnetic, wherein the hinged armature is able to take at least two different positions on the magnetizable body depending on the degree of magnetization of the magnetizable body, for which the hinged armature folds over a hinge axis, and the hinged armature is formed by an armature support carrying a magnetic armature part interacting with a magnetizable body.

2. Magnetic drive according to claim 1, characterized in that the armature support consists of a material different from the one of the magnetic armature part.

3. Magnetic drive according to claim 1, characterized in that the armature support consists of a light-weight material, metal, light metal, aluminum, or (fiber-reinforced) plastic.

4. Magnetic drive according to claim 1, characterized by a beam-shaped armature support.

5. Magnetic drive according to claim 1, characterized in that the magnetic armature part is designed as permanent magnet.

6. Magnetic drive according to claim 1, characterized in that the armature part and the magnetizable body have a width, and the width of the armature part is about 75% to 150% of the width of the magnetizable body, preferably about 80% to 120% of the width of the magnetizable body.

7. Magnetic drive according to claim 1, characterized in that the armature part has a width and the armature support has a length, and the width of the armature part is about between 20% and 55% of the length of the armature support, preferably between 30% and 50% of the length of the armature support.

8. Magnetic drive according to claim 1, characterized in that the armature support has a limiting surface facing the magnetizable body, and/or a limiting surfacing facing away from this body, and the limiting surface of the armature support is formed by two partial surfaces, in particular abutting bluntly on a rocker edge.

9. Magnetic drive according to claim 1, characterized in that a drive housing with a side facing away from the magnetizable body is provided, and the hinged armature is supported movable in the drive housing which, if necessary, also surrounds the magnetizable body, and the drive housing has a lid on the side facing away from the magnetizable body.

10. Magnetic drive according to claim 1, characterized in that a drive housing with a side facing away from the magnetizable body and a lid arranged on the side facing away from the magnetizable body is provided, and the hinged armature is supported movable in the drive housing, which, if necessary, surrounds the magnetizable body, and on the lid one or more support knobs or ribs are provided for the hinged armature.

11. Magnetic drive according to claim 1, characterized in that a drive housing with a lid and a housing part receiving in particular the magnetizable body are provided, and the hinged armature has at least one recess, one passage opening or one guide groove, and on the lid and/or the housing part a guiding pin or guiding bridge projecting in the recess, passage opening or guide groove is provided.

12. Magnetic drive according to claim 1, characterized in that the magnetizable body is formed by a coil carrying windings of wire which can be flown through by electric current.

13. Magnetic drive according to claim 1, characterized in that the magnetizable body is formed by a movable permanent magnet.

14. Magnetic valve formed by a magnetic drive comprising a magnetizable body and an at least partly magnetic hinged armature, wherein the hinged armature is able to take at least two different positions on the magnetizable body depending on the degree of magnetization of the magnetizable body, for that the hinged armature folds over a hinge axis, and the hinged armature is formed by an armature support carrying a magnetic armature part which interacts with the magnetizable body, and the hinged armature has at least one recess, one passage opening or one guide groove, and a valve housing which has at least one passage opening which has to be opened and closed, respectively, and the hinged armature carries at least one tappet interacting with the passage opening.

15. Magnetic valve according to claim 14, characterized in that a drive housing in which the hinged armature is supported moving, and that, if necessary, also surrounds the magnetizable body, and a housing part of the valve housing facing the hinged armature are provided, wherein the housing part of the valve housing facing the hinged armature serves as lid of the drive housing.

16. Magnetic valve according to claim 14, characterized in that a valve space flown through by medium is provided, and the hinged armature is arranged in the valve space flown through by medium.

17. Magnetic valve according to claim 14, characterized in that a valve space flown through by medium and a membrane with a membrane part separating the hinged armature from the valve space are provided, and the tappet acts on the passage opening via the membrane part.
